(19) United States
(12) Patent Application Publication
(10) Pub. No.: US 2019/0304046 A1
(43) Pub. Date: Oct. 3, 2019

(54) Advertising Links

(71) Applicants: Miguel A. Ascarrunz, Dallas, OR (US); Anita G. Ascarrunz, Dallas, OR (US)

(72) Inventors: Miguel A. Ascarrunz, Dallas, OR (US); Anita G. Ascarrunz, Dallas, OR (US)

(21) Appl. No.: 15/932,650

(22) Filed: Apr. 2, 2018

(51) Int. Cl. G06Q 90/00

(52) U.S. Cl. CPC G06Q 90/00; G09F 23/00

(57) ABSTRACT

The invention we call “Advertising Links” consist of using the billions of packages shipped within the United States and around the world each year as an advertising tool. These packages will be used for advertising any product. The advertisement is imprinted on any side of the package, outside and inside.

The boxes that have advertised imprinting outside and inside the shipping box can carry advertise literature, promotions and games inside the shipping boxes. It can be utilized as a teaching tool for many subjects like math, geography, history.

The invention we call “Advertising Links” consist of using the billions of packages shipped within the United States and around the world each year as an advertising tool. These packages will be used for advertising any product. The advertisement is imprinted on any side on the package, outside and inside.

The definition of marketing “advertising”, below, comes from a “Bloomberg” research.

“Advertising is defined as an audio of visual form of marketing, communication that employs an openly sponsored, non-personal message to promote or sell a product, service or idea”.

The advertiser pays for and has control over the message.

Advertisements are mainly done on the radio, newspapers, commercial television, billboards, cable television and on the internet. The following companies in the United States that spend on advertising are: Walt Disney Co. $2.1 billion, L'Oreal $2.2 billion, Fiat Chrysler $2.2 billion, American Express $2.4 billion, Ford Motor Co. $2.5 billion, Verizon Communication $2.5 billion, Comcast $3 billion, General Motors Co. $3.1 billion, AT & T $3.3 billion, Procter & Gamble $4.6 billion.

Directions for the “Advertising Links” will be user-friendly and the advertising in the shipping boxes can be read in most common used languages.

### CROSS REFERENCE TO RELATED APPLICATION

Cross-references to other related applications: US Patent Documents: None.

### STATEMENT OF FEDERALLY SPONSORED RESEARCH/DEVELOPMENT

There are no rights to this invention that was made under federally sponsored research and development.

### NAMES OF THE PARTIES TO A JOINT RESEARCH AGREEMENT

Names of the Inventors:

Miguel A. Ascarrunz, US citizen, resident of the State of Oregon, USA

Anita G. Ascarrunz, US citizen, resident of the State of Oregon, USA

### REFERENCE TO A SEQUENCE LISTING

“Not applicable”.

### BACKGROUND OF THE INVENTION

This invention is original, and clearly describes how it effectively can be advertised with a minimum cost to millions of people by means of shipping boxes.

We claim it as a Utility patent which protects the way an invention is used and how it works, paraphrasing the applicable US patent classification definition. “Utility patents may be granted to anyone who invents or discovers any new and useful process, machine, article of manufacturer or composition of matter, or any useful improvement thereof”.

The invention of the “Advertising Links” is a new step forward in making any advertising more efficient and convenient. Media advertising expenditure in the United States is estimated to be $219 billion for 2018. Global advertising is more than $500 billion per year.

Up until now, anything discovered has not been proven to resemble the way this invention works. Research of prior art has not come out with anything resembling how this invention operates.

### BRIEF SUMMARY OF THE INVENTION

The invention we call “Advertising Links” consist of using the billions of packages shipped within the United States and around the world each year as an advertising tool. These packages will be used for advertising a product, imprinted on any side on the package, inside or outside.

The definition of marketing “advertising”, below, comes from a “Bloomberg” research.

“Advertising is defined as an audio of visual form of “marketing”, communication that employs an openly sponsored, non-personal message to promote or sell a product, service or idea”.

The advertiser pays for and has control over the message.

Advertisements are mainly on radio, newspapers, commercial television, billboards, cable television and on the Internet.

Companies that have proved their ability to personalize advertising on mobile platforms are dominant today.

### BRIEF DESCRIPTION OF THE SEVERAL VIEWS OF THE DRAWINGS

FIG. 1 shows how to advertise on shipping boxes, reflecting what is in the “CLAIMS”.

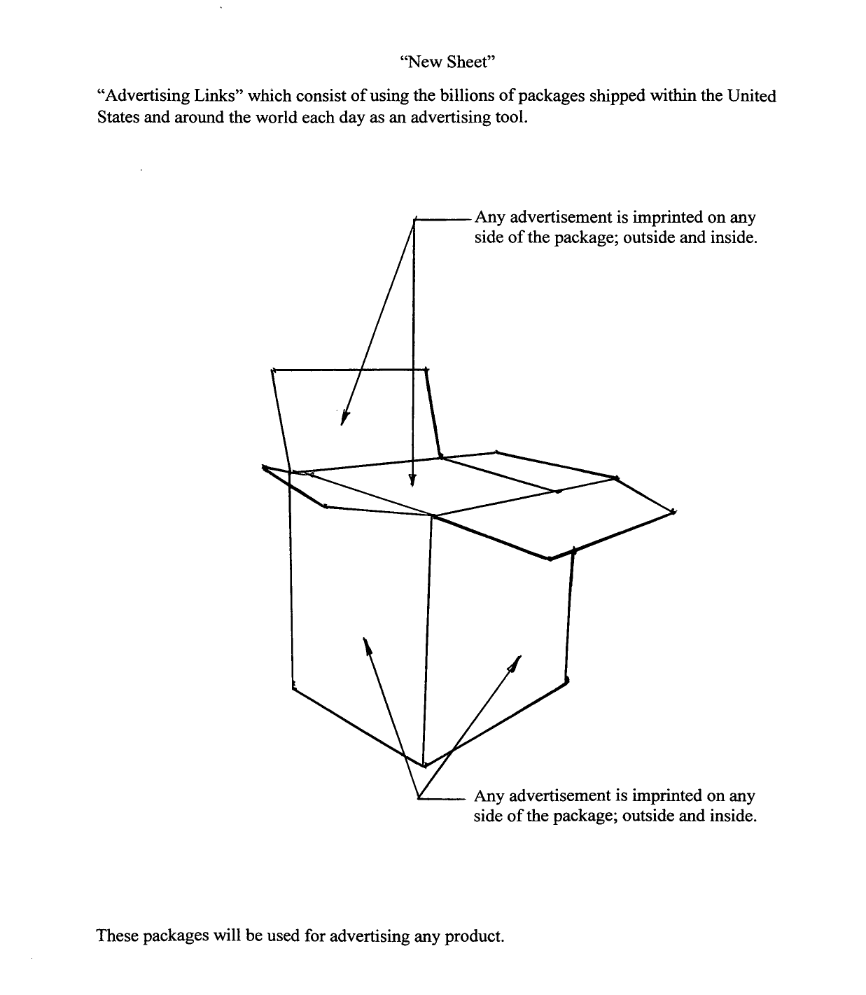

### DETAILED DESCRIPTION OF THE INVENTION

The invention we call “Advertising Links” consist of using the billions of packages shipped within the United States and around the world each year as an advertising tool. These packages will be used for advertising any product. The advertisement is imprinted on any side of the package, outside and inside.

The boxes that have advertised imprinting outside and inside the shipping box can carry advertise literature, promotions and games inside the shipping boxes. It can be utilized as a teaching tool for many subjects like math, geography, history.

With this invention, companies and individuals are restricted of using any advertisement, company logos or symbols on any shipping boxes, unless they have approved legal copy rights.

The definition of marketing “advertising”, below, comes from a “Bloomberg” research.

“Advertising is defined as an audio of visual form of “marketing”, communication that employs an openly sponsored, non-personal message to promote or sell a product, service or idea”.

The advertiser pays for and has control over the message.

This invention is original, and clearly describes how it effectively can be advertised with a minimum cost to millions of people by means of shipping boxes.

Advertisements are mainly on the radio, newspapers, commercial television, billboards, cable television and on the interne.

Companies that have proved their ability to personalize advertising on mobile platforms are dominant today.

Entire Corporations operate solely on their advertising revenue.

The fabricator of the shipping boxes will get the contract of advertisers from any one client.

To achieve this complex undertaking, the fabricator of the shipping boxes will have to utilize personal versatility in the art of display, artists to design the shipping boxes using a myriad of shapes and color style on the boxes in order to draw the attention to people with this new way of advertising.

The stamping of the advertising design on the boxes will be done in large printing facilities. The shipping boxes will also have advertising inside and outside the walls of the merchandize delivered boxes. In addition, it can carry more advertisings inside the boxes.

The advertisings will include: “Missing persons, fugitives of the law, manufacturing companies, retail stores, car manufacturers, credit card companies, cable companies, telephone companies, Hollywood movies and anything that could be advertised with the idea to target the largest customers for immediate sale.

This invention is nut only changing the way advertising is accomplishes but it is a way to build a new form of advertising.

1. We claim the invention we call “Advertising Links” which consist of using the billions of packages shipped within the United States and around the world each year as an advertising tool. These packages will be used for advertising any product. The advertisement is imprinted on any side of the package, outside and inside.
The shipping boxes that have a plurality of advertised imprinting outside and inside the shipping box can carry a plurality of any advertising literature, promotions and games inside the shipping boxes. It can be utilized as a teaching tool for many subjects like math, geography, history.
With this invention, companies and individuals are restricted of using any advertisement, company logos or symbols on any shipping boxes, unless they have approved legal copy rights.
The advertiser pays for and has control over the message.
This invention is original, and clearly describes how it effectively can be advertised with a minimum cost to millions of people by means of shipping boxes in the US and throughout the world.
The fabricator of the shipping boxes will get the contract for advertising from any one client. To achieve this complex undertaking, the fabricator of the shipping boxes will have to utilize personal versatility in the art of display, artists to design the shipping boxes using a plurality of shapes and color style on the boxes in order to draw the attention to people with this new way of advertising.
The stamping of the advertising design on the boxes will be done in large printing facilities. The shipping boxes will also have advertising inside and outside the walls of the merchandize delivering boxes in addition with a plurality of advertising inside the shipping box.
The advertisings will include: “A plurality of topics and companies. Missing persons, fugitives of the law, manufacturing companies, retail stores, car manufacturers, credit card companies, cable companies, telephone companies, Hollywood movies and anything that could be advertised with the idea to target the largest customers for immediate sale.
This invention is not only changing the way advertising is accomplishes but it is a way to build a new form of advertising.
